(19) United States
(12) Patent Application Publication
(10) Pub. No.: US 2012/0327237 A1
(43) Pub. Date: Dec. 27, 2012

(54) VEHICLE-MOUNTED VIDEO RECORDING APPARATUS USING SOLAR CELL

(75) Inventors: Seung Yun OH, Suwon (KR); Jin Mun RYU, Suwon (KR); Jae Hun KIM, Suwon (KR); Tae Young KIM, Suwon (KR); In Taek Song, Suwon (KR)

(73) Assignee: SAMSUNG ELECTRO-MECHANICS CO., LTD.

(21) Appl. No.: 13/534,751

(22) Filed: Jun. 27, 2012

(30) Foreign Application Priority Data
Jun. 27, 2011 (KR) 10-2011-0062425

(51) Int. Cl. H04N 7/18

(52) U.S. Cl. 348/148; 348/E07.085

(57) ABSTRACT

There is provided a vehicle-mounted video recording apparatus. The vehicle-mounted video recording apparatus includes a sub-battery being charged with voltage generated by a solar cell, a power controller supplying an operating voltage using a first voltage from a main vehicle battery and a second voltage from the sub-battery, and a video recorder being supplied with the operating voltage from the power controller.

### CROSS-REFERENCE TO RELATED APPLICATIONS

This application claims the priority of Korean Patent Application No. 10-2011-0062425 filed on Jun. 27, 2011, in the Korean Intellectual Property Office, the disclosure of which is incorporated herein by reference.

### BACKGROUND OF THE INVENTION

1. Field of the Invention

The present invention relates to a vehicle-mounted video recording apparatus allowing for stable power use by utilizing a solar cell and a main vehicle battery.

2. Description of the Related Art

Generally, a black box camera system mounted in a vehicle is an apparatus providing a record of traffic accidents through automatically recording video and audio when an unexpected traffic accident occurs during the driving or parking of a vehicle.

However, vehicle-mounted video recording apparatuses, according to the related art, are supplied with power from a main vehicle battery. In this case, although the main vehicle battery may stably supply power through automatic charging and discharging during the driving of a vehicle, when the video recording apparatus is supplied with power from the main vehicle battery under the condition that an engine is stopped, there is a problem in that the main vehicle battery may be discharged.

### SUMMARY OF THE INVENTION

An aspect of the present invention provides a vehicle-mounted video recording apparatus allowing for stable power use by utilizing a solar cell and a main vehicle battery.

According to an aspect of the present invention, there is provided a vehicle-mounted video recording apparatus, including: a sub-battery being charged with voltage generated by a solar cell; a power controller supplying an operating voltage using a first voltage from a main vehicle battery and a second voltage from the sub-battery; and a video recorder being supplied with the operating voltage from the power controller.

The power controller may include a switching circuit unit selecting one of the first voltage and the second voltage according to a control voltage from the outside and supplying the selected voltage as the operating voltage.

The switching circuit unit of the power controller may supply the first voltage as the operating voltage according to the control voltage when an engine is operating. The switching circuit unit may select the second voltage according to the control voltage when the engine is stopped, and supply the selected second voltage as the operating voltage.

The video recorder may include a camera unit including at least one camera; and a recording unit storing signals from the camera unit.

The power controller may include a comparing circuit unit comparing the first voltage with the second voltage and supplying a control voltage to allow a relatively higher voltage to be selected; and a switching circuit unit selecting one of the first voltage and the second voltage according to the control voltage from the comparing circuit unit and supplying the selected voltage as the operating voltage.

The comparing circuit unit may supply the control voltage having a high voltage level when the first voltage is higher than the second voltage, or may supply the control voltage having a low voltage level when the first voltage is not higher than the second voltage.

The switching circuit unit may select the first voltage when the control voltage has the high voltage level, or may select the second voltage when the control voltage has the low voltage level.

The video recorder may include a camera unit including at least one camera; and a recording unit storing signals from the camera unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a vehicle-mounted video recording apparatus according to an embodiment of the present invention;

FIG. 2 is a diagram showing a first example of a power controller according to an embodiment of the present invention;

FIG. 3 is a diagram showing a second example of a power controller according to an embodiment of the present invention;

FIG. 4 is a diagram showing an example in which a solar cell according to an embodiment of the present invention is mounted on a vehicle;

FIG. 5 is a diagram showing an example in which a camera unit of a video recorder according to an embodiment of the present invention is mounted in a vehicle; and

FIG. 6 is a diagram showing an example in which a recording unit of a video recorder according to an embodiment of the present invention is mounted in a vehicle.

### DETAILED DESCRIPTION OF THE INVENTION

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals denote like components having substantially the same constitution and function throughout the drawings of the present invention.

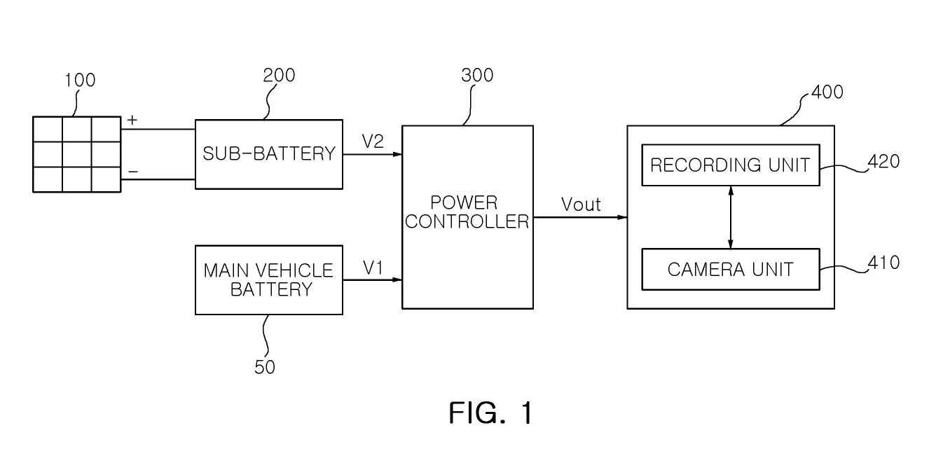

FIG. 1 is a block diagram of a vehicle-mounted video recording apparatus according to an embodiment of the present invention.

Referring to FIG. 1, a vehicle-mounted video recording apparatus according to the embodiment of the present invention may include a sub-battery 200 charged with voltage generated by a solar cell 100, a power controller 300 supplying an operating voltage Vout using a first voltage V1 from a main vehicle battery 50 and a second voltage V2 from the sub-battery 200, and a video recorder 400 to which the operating voltage Vout is supplied from the power controller 300.

The solar cell 100 converts solar energy into electrical energy to output a voltage according to the strength of solar energy.

The sub-battery 200, a secondary battery such as a chargeable lead storage battery, may be charged with the voltage generated by the solar cell 100.

The main vehicle battery 50 may supply a predetermined voltage (for example, 11V to 14V) by repeating charging and discharging cycles while an engine is operating, and may only be discharged when an engine is stopped, and therefore, the voltage thereof may be gradually reduced.

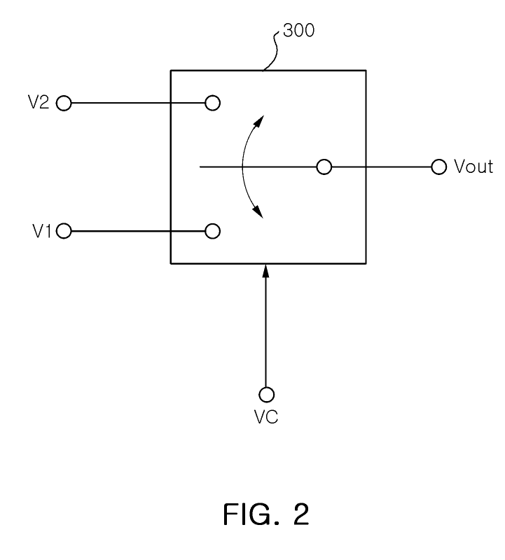

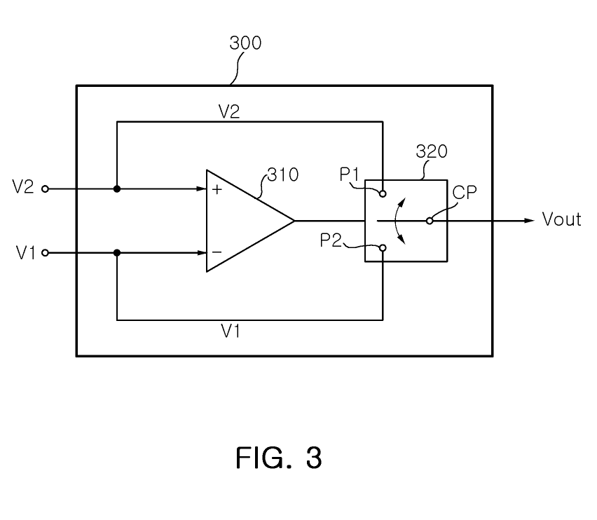

Meanwhile, the power controller 300 for supplying the operating voltage Vout by using the first voltage V1 from the main vehicle battery 50 and the second voltage V2 from the sub-battery 200 may be variously implemented, which will be described with reference to FIGS. 2 and 3.

FIG. 2 is a diagram showing a first example of a power controller according to an embodiment of the present invention.

The power controller 300 may include a switching circuit unit selecting one of the first voltage V1 and the second voltage V2 according to a control voltage VC from the outside and supplying the selected voltage as the operating voltage Vout.

In more detail, the switching circuit unit of the power controller 300 may be configured to supply the first voltage V1 as the operating voltage Vout when the engine is operating and select the second voltage V2 and supply the selected second voltage V2 as the operating voltage Vout when the engine is stopped, according to the control voltage VC.

FIG. 3 is a diagram showing a second example of a power controller according to an embodiment of the present invention.

Referring to FIG. 3, the power controller 300 may include a comparing circuit unit 310 comparing the first voltage V1 with the second voltage V2 and supplying the control voltage VC to allow a relatively higher voltage to be selected, and a switching circuit unit 320 selecting one of the first voltage V1 and the second voltage V2 according to the control voltage VC from the comparing circuit unit 310 and supplying the selected voltage as the operating voltage Vout.

The comparing circuit unit 310 may be configured to supply the control voltage VC having a high voltage level when the first voltage V1 is higher than the second voltage V2, or to supply the control voltage VC having a low voltage level when the first voltage V1 is not higher than the second voltage V2.

In FIG. 3, the switching circuit unit 320 may be configured to select the first voltage V1 when the control voltage VC has a high voltage level and select the second voltage V2 when the control voltage VC has a low voltage level.

In this case, the video recorder 400 may be configured to include a camera unit 410 including at least one camera and a recording unit 420 storing signals from the camera unit 410.

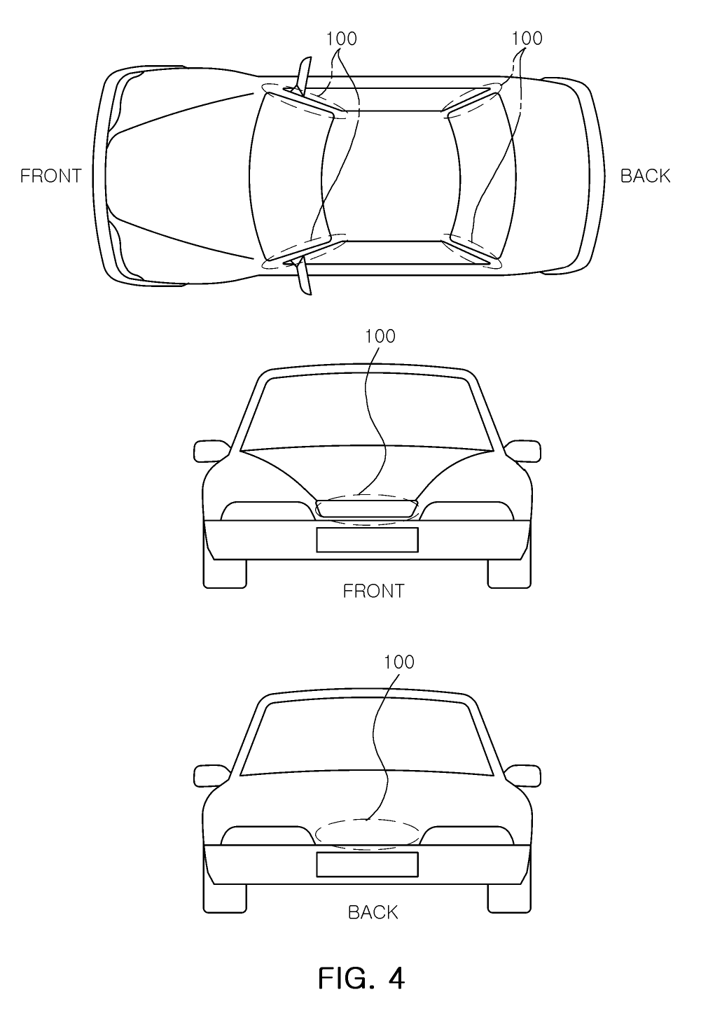

FIG. 4 is a diagram showing an example in which a solar cell according to an embodiment of the present invention is mounted on a vehicle.

The solar cell 100 according to the embodiment of the present invention may be variously mounted on several parts of a vehicle. For example, as shown in FIG. 4, the solar cell may be mounted on a pillar A between a loop panel and a front wheel house of a vehicle, on a pillar C between the loop panel and a quarter panel, on a pillar B between the loop panel and a door of a vehicle, and the like.

In addition, the solar cell 100 according to the embodiment of the present invention may be mounted on a part of or the entirety of a front bumper of a vehicle or on a part of or the entirety of a rear trunk of a vehicle.

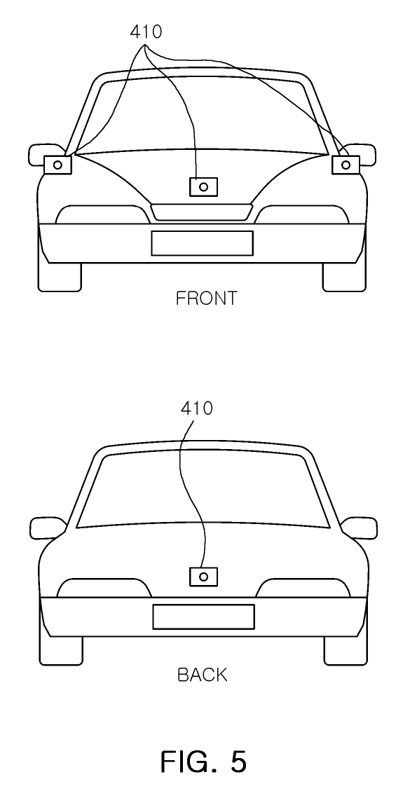

FIG. 5 is a diagram showing an example in which a camera unit of a video recorder according to an embodiment of the present invention is mounted in a vehicle.

Referring to FIG. 5, the camera unit 410 of the video recorder 400 according to the embodiment of the present invention may be mounted in side mirrors, a front bumper, and a rear trunk so as to image a following vehicle.

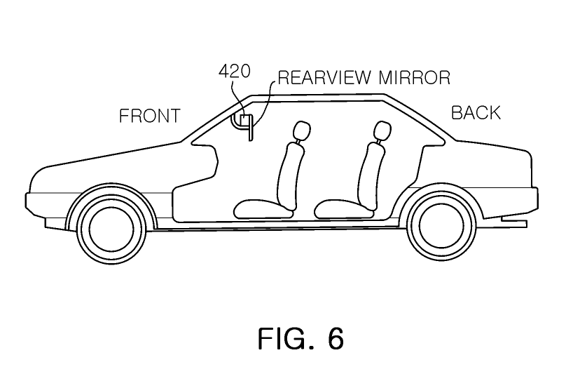

FIG. 6 is a diagram showing an example in which a recording unit of a video recorder according to an embodiment of the present invention is mounted in a vehicle.

Referring to FIG. 6, the recording unit 420 of the video recorder 400 according to the embodiment of the present invention may be mounted behind a rearview mirror inside a vehicle.

Hereinafter, the operations and effects of the present invention will be described in detail with reference to the accompanying drawings.

First, referring to FIG. 1, in the vehicle-mounted video recording apparatus according to the embodiment of the present invention, the sub-battery 200 is charged with voltage generated by the solar cell 100. Here, the sub-battery 200, a secondary battery such as a chargeable lead storage battery, may be configured to store voltage generated by the solar cell 100.

In this case, the solar cell 100 converts solar energy into electrical energy to output voltage according to the strength of solar energy. For example, the solar sell may output a maximum voltage when solar energy is sufficient or output a voltage lower than the maximum voltage when solar energy is insufficient.

Meanwhile, the main vehicle battery 50 may supply a predetermined voltage (for example, 11V to 14V) through repeating charging and discharging when an engine is operating, and may only be discharged when an engine is stopped, and therefore, the voltage thereof may be gradually reduced.

Next, the power controller 300 supplies the operating voltage Vout using the first voltage V1 from the main vehicle battery 50 and the second voltage V2 from the sub-battery 200.

Therefore, the video recorder 400 is supplied with the operating voltage Vout from the power controller 300.

In this case, the video recorder 400 may include the camera unit 410 and the recording unit 420. The camera unit 410 and the recording unit 420 are supplied with the operating voltage Vout from the power controller 300. The camera unit 410 may include at least one camera to acquire videos therethrough and provide the acquired videos to the recording unit 420.

In this case, the recording unit 420 may store the signals from the camera unit 410.

On the other hand, the power controller 300 for supplying the operating voltage Vout by using the first voltage V1 from the main vehicle battery 50 and the second voltage V2 from the sub-battery 200 may be variously implemented, which will be described with reference to FIGS. 2 and 3.

FIG. 2 is a diagram showing a first example of a power controller according to an embodiment of the present invention.

In FIG. 2, the power controller 300 may include the switching circuit unit, wherein the switching circuit unit may select one of the first voltage V1 and the second voltage V2 according to the control voltage VC from the outside and supply the selected voltage as the operating voltage Vout.

In more detail, the switching circuit unit of the power controller 300 may supply the first voltage V1 as the operating voltage Vout when the engine is operating and supply the second voltage V2 as the operating voltage Vout when the engine is stopped, according to the control voltage VC.

Here, the control voltage VC may be, for example, a high level voltage whose level is higher than a predetermined reference voltage when the engine is operating, while the control voltage VC may be a low level voltage whose level is lower than the predetermined reference voltage when the engine is stopped, and the control voltage may be supplied from the power controller of a vehicle as signals according to the state of the engine.

FIG. 3 is a diagram showing a second example of a power controller according to an embodiment of the present invention.

In FIG. 3, the power controller 300 may include the comparing circuit unit 310 and the switching circuit unit 320. The comparing circuit unit 310 may compare the first voltage V1 with the second voltage V2 and supply the control voltage VC to the switching circuit unit 320 to allow a relatively higher voltage to be selected.

Next, the switching circuit unit 320 may select one of the first voltage V1 and the second voltage V2 according to the control voltage VC from the comparing circuit unit 310 and may supply the selected voltage as the operating voltage Vout.

In a more detailed example, the comparing circuit unit 310 may supply the control voltage VC having a high voltage level when the first voltage V1 is higher than the second voltage V2, or supply the control voltage VC having a low voltage level when the first voltage V1 is not higher than the second voltage V2.

Here, the switching circuit unit 320 may select the first voltage V1 when the control voltage VC has the high voltage level and select the second voltage V2 when the control voltage VC has the low voltage level.

An example in which the solar cell 100 according to the embodiment of the present invention is mounted on a vehicle will be described with reference to FIG. 4. The solar cell 100 according to the embodiment of the present invention may be variously mounted on several parts of a vehicle.

For example, as shown in FIG. 4, the solar cell may be mounted on a pillar A between a loop panel and a front wheel house of a vehicle, on a pillar C between the loop panel and a quarter panel, on a pillar B between the loop panel and a door of a vehicle, and the like.

In addition, the solar cell 100 according to the embodiment of the present invention may be mounted on a part of or the entirety of a front bumper of a vehicle or on a part of or the entirety of a rear trunk of a vehicle.

Describing an example in which the camera unit 410 of the video recorder 400 according to the embodiment of the present invention is mounted in a vehicle, with reference to FIG. 5, the camera unit 410 of the video recorder 400 according to the embodiment of the present invention may be mounted in side mirrors, the front bumper, and the rear trunk so as to image a following vehicle.

Describing an example in which the recording unit 420 of the video recorder 400 according to the embodiment of the present invention is mounted in a vehicle, with reference to FIG. 6, the recording unit 420 of the video recorder 400 according to the embodiment of the present invention may be mounted behind a rearview mirror inside a vehicle. The mounting position of the recording unit 420 is not limited thereto.

As described above, in the embodiments of the present invention, power may be stably supplied for recording videos using the solar cell and the main vehicle battery.

As set forth above, according to embodiments of the present invention, a vehicle-mounted video recording apparatus allows for stable power use in recording videos by utilizing a solar cell and a main vehicle battery, thereby securing reliability in recording videos of unexpected traffic accidents at all times.

While the present invention has been shown and described in connection with the embodiments, it will be apparent to those skilled in the art that modifications and variations can be made without departing from the spirit and scope of the invention as defined by the appended claims.

What is claimed is:

1. A vehicle-mounted video recording apparatus, comprising:
a sub-battery being charged with voltage generated by a solar cell;
a power controller supplying an operating voltage using a first voltage from a main vehicle battery and a second voltage from the sub-battery; and
a video recorder being supplied with the operating voltage from the power controller.

2. The vehicle-mounted video recording apparatus of claim 1, wherein the power controller includes a switching circuit unit selecting one of the first voltage and the second voltage according to a control voltage from the outside and supplying the selected voltage as the operating voltage.

3. The vehicle-mounted video recording apparatus of claim 2, wherein the switching circuit unit of the power controller supplies the first voltage as the operating voltage according to the control voltage when an engine is operating, and
the switching circuit unit selects the second voltage according to the control voltage when the engine is stopped, and supplies the selected second voltage as the operating voltage.

4. The vehicle-mounted video recording apparatus of claim 3, wherein the video recorder includes:
a camera unit including at least one camera; and
a recording unit storing signals from the camera unit.

5. The vehicle-mounted video recording apparatus of claim 1, wherein the power controller includes:
a comparing circuit unit comparing the first voltage with the second voltage and supplying a control voltage to allow a relatively higher voltage to be selected; and
a switching circuit unit selecting one of the first voltage and the second voltage according to the control voltage from the comparing circuit unit and supplying the selected voltage as the operating voltage.

6. The vehicle-mounted video recording apparatus of claim 5, wherein the comparing circuit unit supplies the control voltage having a high voltage level when the first voltage is higher than the second voltage, or supplies the control voltage having a low voltage level when the first voltage is not higher than the second voltage.

7. The vehicle-mounted video recording apparatus of claim 6, wherein the switching circuit unit selects the first voltage when the control voltage has the high voltage level, or selects the second voltage when the control voltage has the low voltage level.

8. The vehicle-mounted video recording apparatus of claim 7, wherein the video recorder includes:
a camera unit including at least one camera; and
a recording unit storing signals from the camera unit.
